(19) United States
(12) Patent Application Publication
(10) Pub. No.: US 2003/0033354 A1
(43) Pub. Date: Feb. 13, 2003

(54) System and method for caching entitlement sets

(76) Inventors: Kenneth Joseph Schulz, Los Altos, CA (US); Joseph Gerard Moffat, Los Gatos, CA (US); Daniel Scott Jorgenson, San Jose, CA (US); Ahmed Khattab, Milpitas, CA (US); Robert Maslin Hull, Mountain View, CA (US); Gautam Shah, Bangalore (IN)

Correspondence Address: HEWLETT-PACKARD COMPANY, Intellectual Property Administration, P. O. Box 272400, Fort Collins, CO, 80527-2400, US

(21) Appl. No.: 09/924,299

(22) Filed: Aug. 8, 2001

(51) Int. Cl. G06F 15/16

(52) U.S. Cl. 709/203; 709/250

(57) ABSTRACT

Systems and methods for caching entitlement sets are provided. A representative system is implemented as a program for caching an entitlement set. The entitlement set designates services and products a user is entitled to access. Such a program can include: logic configured to receive a login request from the user; logic configured to determine whether a dirty buffer related to the user exists, the dirty buffer having been created after a triggering event, the dirty buffer indicating the triggering event has occurred; logic configured to read a preexisting entitlement set from a memory element if the dirty buffer does not exist; and logic configured to calculate a new entitlement set if the dirty buffer does exist.

### TECHNICAL FIELD

The present invention is generally related to computer networks and, more particularly, is related to a system and method for caching entitlement sets.

### BACKGROUND

Organizations may use network based information technology resource centers, such as Hewlett Packard's ITRC, to provide a single entry point to customer support services and products. The information technology resource center may include features such as: (1) maintenance and support, including hardware, software, databases, services and tools; (2) planning, design and implementation for new information technology projects; (3) training and education; (4) forums for user collaboration; and (5) other known features.

An organization may use a portal to customize the information technology resource centers to reflect a user's work preferences and the user's interests. The objective of a customized information technology resource center is to make the user's experience with the information technology resource center as quick, easy, and effective as possible. This is accomplished by providing quick access to tools and features the user includes in the customized information technology resource center, allowing easy modification of the customized information technology resource center to reflect the user's changing needs, and making effective use of information and tools from the portal. In addition to any customization done by a user, the information technology resource center may employ a personalization engine to make system-managed aspects of the information technology resource center more relevant to the user.

In order to utilize a service on the customized information technology resource center, the user must generally meet the access requirements for that service and the user's warranty or support coverage must generally be linked to the customized information technology resource center user identification. Access requirements may vary by information technology resource center service. The user may be able to browse some services and register only if the user decides to purchase that service(s). Other services may require registration in the information technology resource center and a warranty or a specified service agreement coverage with the organization. The information technology resource center may offer on-line purchase of per incident support services.

A user of the information technology resource center generally has a complete user profile that includes an entitlement set and the user's personal information. The entitlement set is based on the linked agreements to which the user has access. In relation to any particular linked agreement, the user may be a primary user or a secondary user depending upon the scope of the entitlements to which the user has access. The personal information may include the user's name, phone number, email address, country, language preference, time zone at the user's location, and other personal information.

The user's complete user profile is generally read from one or more databases and the entitlement set is calculated when a user logs in to the information technology resource center. A first database may include the personal information. The first database, or a second database, may include linked agreements. The information technology resource center may access the first database, and the second database if applicable, and then calculate the entitlements set during login.

If the user has warranty or support agreement coverage, the coverage generally must be linked to the user's identification information. This coverage link enables the information technology resource center to provide access to all of the user's entitled services. Linking or attaching warranties or support agreements to the user's information technology resource center user identification information is typically done at the time the user registers for the information technology resource center, but can be accomplished at any time.

Once the user is logged in to the information technology resource center, the user can perform review or enable services on the information technology resource center. For example, the user can review warranties and support agreements currently linked to the user's User ID. Also, the user can link one or more qualifying system handles or warranties to the user's identification information to formalize the user's entitlement set to additional information technology resource center services.

Unfortunately, the process of calculating the entitlement set at runtime often causes undesirable delay in logging on to the information technology resource center computer system. This problem is particularly acute when a large number of agreements are associated with the user. Thus, a heretofore unaddressed need exists in the industry to address the aforementioned deficiencies and inadequacies.

### SUMMARY

The present invention provides a system and method for caching entitlement sets. Briefly described, in architecture, one embodiment of the system, among others, can be implemented as a program for caching an entitlement set. The program may be stored as a computer readable medium. The entitlement set designates services and products a user is entitled to access. The program may include logic configured to receive a login request from the user. The program may also include logic configured to determine whether a dirty buffer related to the user exists. The dirty buffer having been created after a triggering event. The dirty buffer indicating the triggering event has occurred. The program may also include logic configured to read a preexisting entitlement set from a memory element if the dirty buffer does not exist. The program may also include logic configured to calculate a new entitlement set if the dirty buffer does exist.

The present invention can also be viewed as providing methods for caching entitlement sets. In this regard, one embodiment of such a method, among others, can be broadly summarized by the following steps: receiving a login request from the user; determining whether a dirty buffer related to the user exists, the dirty buffer having been created after a triggering event, the dirty buffer indicating the triggering event has occurred; reading a preexisting entitlement set from a memory element if the dirty buffer does not exist; and calculating a new entitlement set if the dirty buffer does exist.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram showing an exemplar network in which the caching entitlement system and method may be practiced. FIG. 1 includes a server computer.

FIG. 2 is a block diagram showing the server computer of FIG. 1. The server computer includes an embodiment of the caching entitlement set system.

FIG. 3 is a block diagram showing the server computer of FIG. 1. The server computer includes an embodiment of the caching entitlement set software.

FIG. 4 is a flowchart illustrating one embodiment of the caching entitlement set software of FIG. 3.

FIG. 5 is a flowchart illustrating another embodiment of the caching entitlement set software of FIG. 3.

### DETAILED DESCRIPTION

The system and method for caching entitlement sets provides a shorted login time for some customer logins to a network. The network may be an information technology resource center. The system and method for caching entitlement sets creates a dirty buffer after a triggering event has occurred. The triggering event may be one or more events that may have an effect on the entitlement set. If the dirty buffer exists, the system and method for caching entitlement sets calculates a new entitlement set. If the dirty buffer does not exist, the system and method for caching entitlement sets reads a preexisting entitlement set from a memory element.

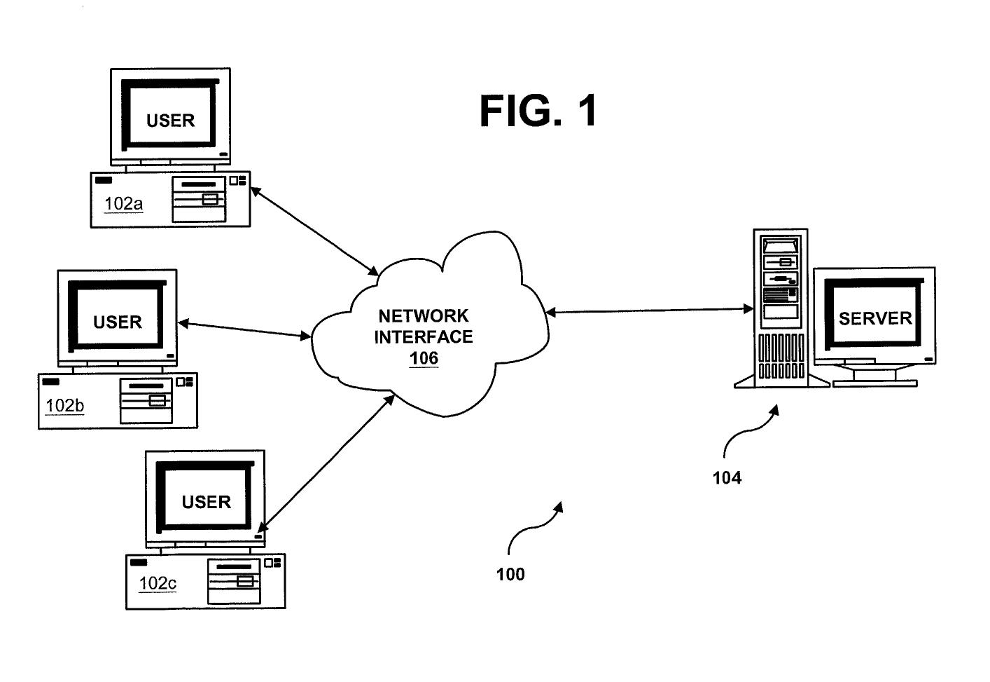

Referring now to the drawings, wherein like reference numerals designate corresponding parts throughout the drawings, FIG. 1 is a block diagram showing an exemplar network 100 in which the caching entitlement set system and method may be practiced. FIG. 1 portrays a network 100 that illustrates the flexibility, expandability, and platform independence in which the caching entitlement set system of the present invention may be implemented. Referring to FIG. 1, a series of user computers 102a, 102b, 102c are connected to a server computer 104 via a network interface 106. The network interface 106 may be, for example, but is not limited to, a dial-in network, local area network (LAN), wide area network (WAN), public switched telephone network (PSTN), Intranet, Internet, Ethernet type networks, and the like. The user computers 102a, 102b, 102c (hereinafter, 102) may be located within a LAN, WAN, PSTN, Intranet, Internet, Ethernet type networks, or the like. It should be noted that the number of user computers 102 and server computers 104 may differ from the number presently illustrated.

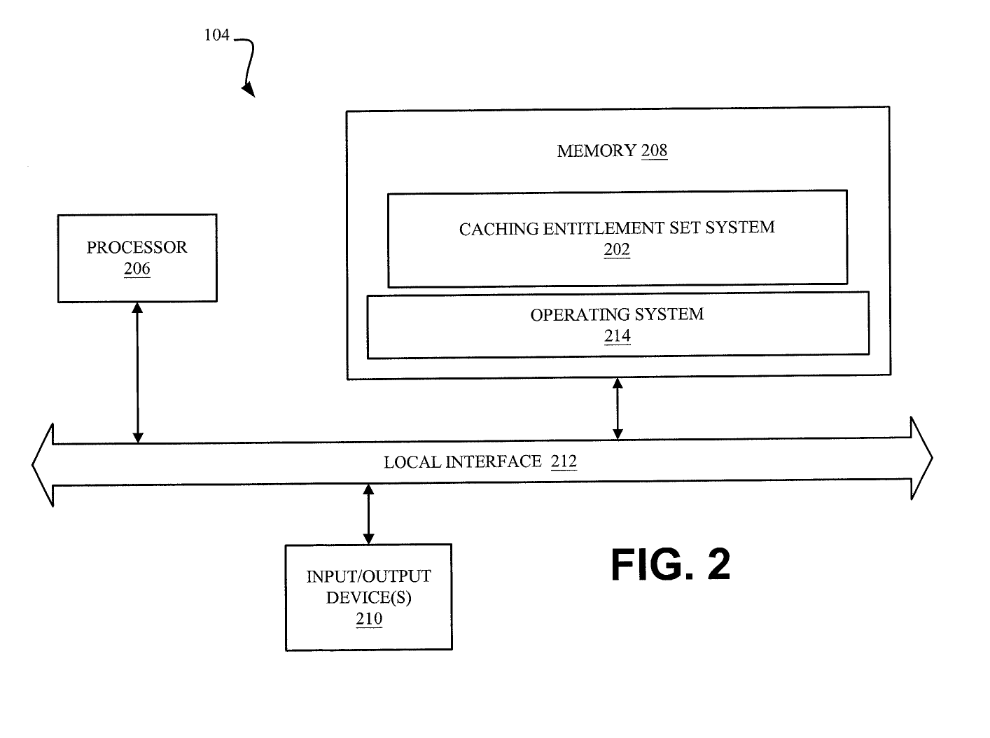

FIG. 2 is a block diagram showing the server computer 104 of FIG. 1. The server computer 104 (FIG. 1) includes an embodiment of the caching entitlement set system 202. The caching entitlement set system 202 of the invention can be implemented in software (e.g., firmware), hardware, or a combination thereof. The caching entitlement set system 202 may be implemented in software, as an executable program, and is executed by a special or general purpose digital computer, such as a personal computer (PC; IBM-compatible, Apple-compatible, or otherwise), workstation, minicomputer, or mainframe computer. An example of a general purpose computer that can implement the caching entitlement set system 202 of the present invention is shown in FIG. 2.

Generally, in terms of hardware architecture, as shown in FIG. 2, the server computer 104 (FIG. 1) includes a processor 206, memory 208, and one or more input and/or output (I/O) devices 210 (or peripherals) that are communicatively coupled via a local interface 212. The local interface 212 can be, for example but not limited to, one or more buses or other wired or wireless connections, as is known in the art. The local interface 212 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 206 is a hardware device for executing software, particularly that stored in memory 208. The processor 206 can be any custom made or commercially available processor, a central processing unit (CPU), an auxiliary processor among several processors associated with the server computer 104 (FIG. 1), a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard Company, an 80×86 or Pentium series microprocessor from Intel Corporation, a PowerPC microprocessor from IBM, a Sparc microprocessor from Sun Microsystems, Inc, or a 68××× series microprocessor from Motorola Corporation.

The memory 208 can include any one or combination of volatile memory elements (e.g., random access memory (RAM, such as DRAM, SRAM, SDRAM, etc.)) and persistent memory elements (e.g., ROM, hard drive, tape, CDROM, etc.). Moreover, the memory 208 may incorporate electronic, magnetic, optical, and/or other types of storage media. Note that the memory 208 can have a distributed architecture, where various components are situated remote from one another, but can be accessed by the processor 206.

The software in memory 208 may include one or more separate programs, each of which comprises an ordered listing of executable instructions for implementing logical functions. In the example of FIG. 2, the software in the memory 208 includes the caching entitlement set system 202 in accordance with the present invention and a suitable operating system 214. A nonexhaustive list of examples of suitable commercially available operating systems 214 is as follows: (a) a Windows operating system available from Microsoft Corporation; (b) a Netware operating system available from Novell, Inc.; (c) a Macintosh operating system available from Apple Computer, Inc.; (d) a NetWare operating system available from Novell, Inc.; (e) a UNIX operating system, which is available for purchase from many vendors, such as the Hewlett-Packard Company, Sun Microsystems, Inc., and AT&T Corporation; (f) a LINUX operating system, which is freeware that is readily available on the Internet; (g) a run time Vxworks operating system from WindRiver Systems, Inc.; or (h) an appliance-based operating system, such as that implemented in handheld computers or personal data assistants (PDAs) (e.g., PalmOS available from Palm Computing, Inc., and Windows CE available from Microsoft Corporation). The operating system 214 essentially controls the execution of other computer programs, such as the caching entitlement set system 202, and provides scheduling, input-output control, file and data management, memory management, and communication control and related services.

The caching entitlement set system 202 may be a source program, executable program (object code), script, or any other entity comprising a set of instructions to be performed. When a source program, the program is translated by a compiler, assembler, interpreter, or the like, which may or may not be included within the memory 208, so as to operate properly in connection with the operating system 214. Furthermore, the caching entitlement set system 202 can be written as (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada. In the currently contemplated best mode of practicing the invention, the caching entitlement set software 202 is written in C.

The I/O devices 210 may include input devices, for example but not limited to, ports compatible with the network interface 106, a keyboard, mouse, scanner, microphone, etc. Furthermore, the I/O devices 210 may also include output devices, for example but not limited to ports compatible with the network interface 106, a printer, display, etc. Finally, the I/O devices 210 may further include devices that communicate both inputs and outputs, for instance but not limited to ports compatible with the network interface 106, a modulator/demodulator (modem; for accessing another device, system, or network), a radio frequency (RF) or other transceiver, a telephonic interface, a bridge, a router, etc.

If the server computer 104 (FIG. 1) is a PC, workstation, or the like, the software in the memory 208 may further include a basic input output system (BIOS) (omitted for simplicity). The BIOS is a set of essential software routines that initialize and test hardware at startup, start the operating system 214, and support the transfer of data among the hardware devices. The BIOS is stored in ROM so that the BIOS can be executed when the server computer 104 (FIG. 1) is activated.

When the server computer 104 (FIG. 1) is in operation, the processor 206 is configured to execute software stored within the memory 208, to communicate data to and from the memory 208, and to generally control operations of the server computer 104 (FIG. 1) pursuant to the software. The caching entitlement set system 202 and the operating system 214, in whole or in part, but typically the latter, are read by the processor 206, perhaps buffered within the processor 206, and then executed.

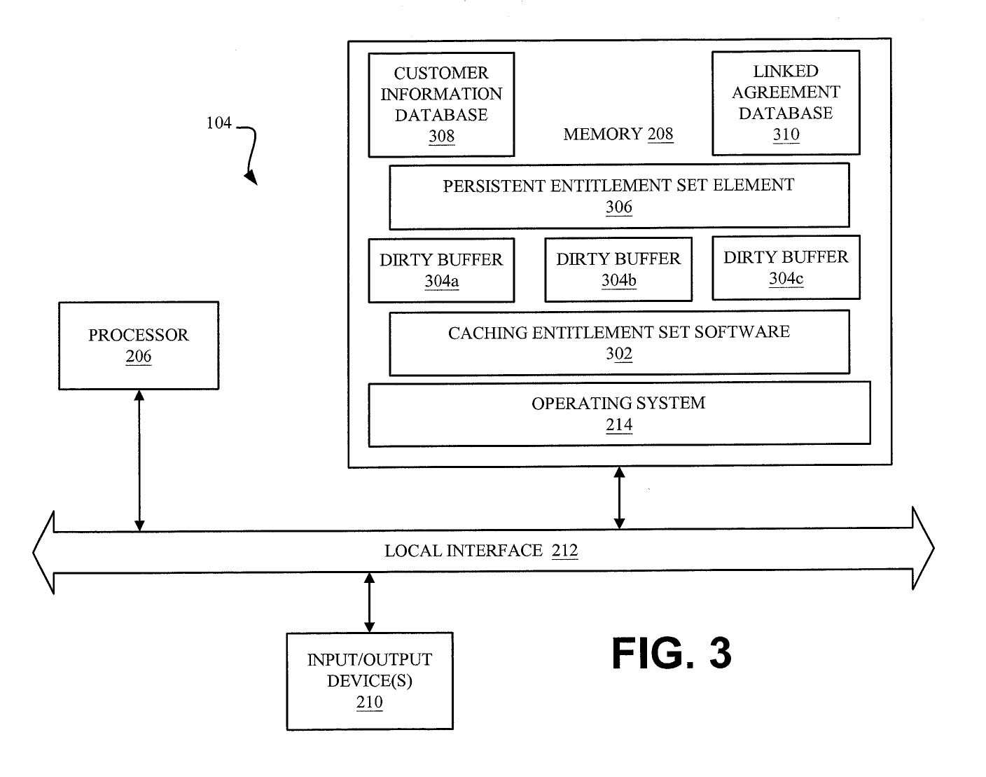

FIG. 3 is a block diagram showing the server computer 104 of FIG. 1. The server computer 104 includes an embodiment of the caching entitlement set software 302. In FIG. 3, memory includes a plurality of dirty buffers 304 represented in FIG. 3 as dirty buffers 304a, 304b, and 304c. The dirty buffers 304 indicate whether a triggering event has occurred. Memory also includes a persistent entitlement set element 306, a customer information database 308, and a linked agreement database 310. The persistent entitlement set element 306 retains an entitlement set for a user. The customer information database 308 stores the user's personal information. The linked agreement database 310 stores information regarding linked agreements associated with the user.

When the caching entitlement set system 202 is implemented in software, as is shown in FIG. 3, it should be noted that the caching entitlement set system 202 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The caching entitlement set system 202 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the caching entitlement set system is implemented in hardware, the caching entitlement set system can be implemented with any, or a combination of, the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

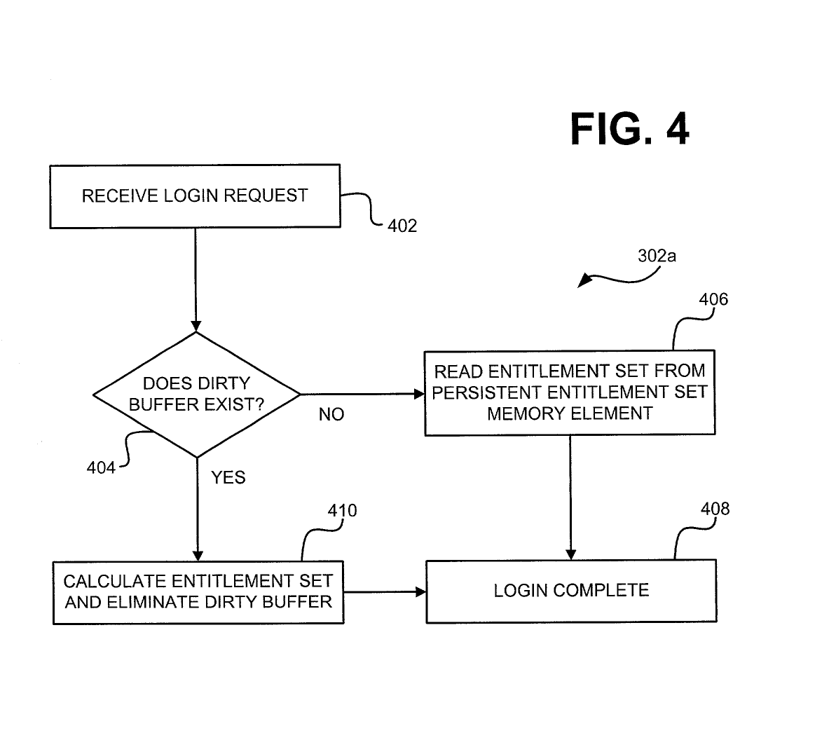

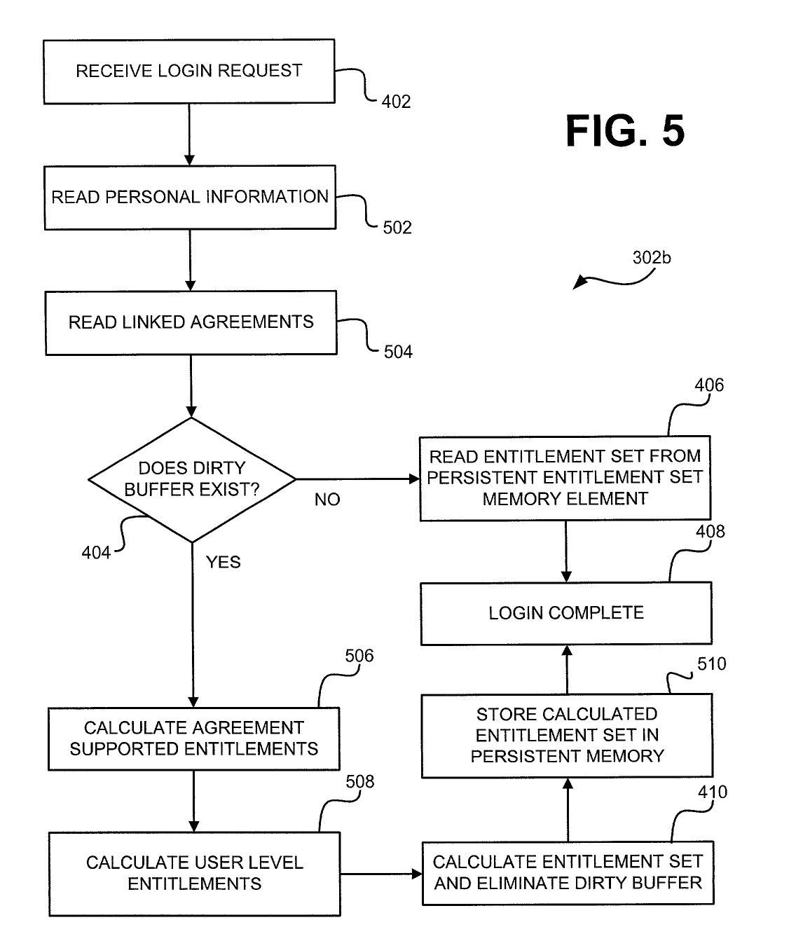

FIGS. 4 and 5 are flowcharts illustrating the functionality of embodiments of the caching entitlement set system and method. In this regard, each block of the flowcharts represents a module, segment, or portion of code, which comprises one or more executable instructions for implementing the specified logical function(s). It should also be noted that in some alternative implementations, the functions noted in the blocks may occur out of the order noted in FIGS. 4 and 5. For example, two blocks shown in succession in FIGS. 4 and 5 may in fact be executed substantially concurrently or the blocks may sometimes be executed in the reverse order, depending upon the functionality involved, as will be further clarified hereinbelow.

FIG. 4 is a flowchart illustrating an embodiment 302a of the caching entitlement set software 302 of FIG. 3. The caching entitlement set software 302a of FIG. 5 illustrates the functionality of an embodiment 392a of the caching entitlement set system and method.

In block 402, the caching entitlement set software 302a receives a user login request. The user login request generally includes user identification information and a password. The user identification information may be an arbitrary term selected by the user. The user identification information may also be the user's email address, the user's social security number, and/or a term determined by the information technology resource center. The password is generally at least six characters and may include numbers, letters, and other symbols. The user identification information and password are generally entered at a user computer 102 (FIG. 1) connected to the server computer 104 (FIG. 1) by network 106 (FIG. 1). After the user enters the user identification information and password, the login request is transmitted to the server computer 104 by clicking on “OK,” by hitting the enter or return key, or by other triggering systems and methods known to those having ordinary skill in the art.

In block 404, the caching entitlement set software 302a determines whether a triggering event has occurred. The information regarding whether a triggering event has occurred may be indicated by the creation of a dirty buffer 304 (FIG. 3). The dirty buffer 304 (FIG. 3), if it exists, indicates a triggering event has occurred that may have an effect on the user's entitlement set. The dirty buffer 304 (FIG. 3) may also store data to identify the triggering event to the caching entitlement set system.

The caching entitlement software 302a creates the dirty buffer 304 after one or more triggering events. The triggering events are any events that may change the user's entitlement set. The triggering events include the creation of a new linking agreement, the introduction of a new user to the information technology resource center, a new sharing of a linking agreement, a re-assigning of a linking agreement, a change in the user's country of registration, a new release of the information technology resource center software, and a granting of new entitlements such as for marketing. The new linking agreement may be based upon a hardcopy contract between the organization and a customer or an on-line purchase of new entitlements. In the case of a hardcopy contract, the new entitlements based on the hardcopy contract can be entered into the information technology resource center in a manner that is known to those of ordinary skill in the art.

The caching entitlement set system potentially results in reduced time required for completion of the information technology resource center login process. Since dirty buffer 304 (FIG. 3) triggering events typically are less frequent than user logins, the caching entitlement set system saves the time required to calculate the entitlement set when a dirty buffer 304 (FIG. 3) exists. In the caching entitlement set system, the new entitlement set typically is calculated upon the occurrence of a triggering event.

If the caching entitlement set software 302a determines a dirty buffer 304 (FIG. 3) does not exist in block 404, the caching entitlement set software 302a goes to block 406. In block 406, the caching entitlement set software 302a reads the entitlement set from the persistent entitlement set element 306 (FIG. 3). The persistent entitlement set element 306 (FIG. 3) retains data in the server computer 104 (FIG. 1) sub-system managing the persistent entitlement set element 306 (FIG. 3). The persistent entitlement set element 306 (FIG. 3) retains data in the server computer 104 (FIG. 1) regardless of whether the server computer 104 (FIG. 1) sub-system is operational. The server computer 104 (FIG. 1) sub-system may not be operational due to the sub-system being switched off. In this manner, data stored in persistent entitlement set element 306 (FIG. 3) is generally protected from loss or damage.

The entitlement set designates the services and products the user is entitled to access in the information technology resource center. The entitlement set may be the entire set of services and products the customer is entitled to access in the information technology resource center. However, when the customer has many users, there are generally at least two user entitlement levels. The user entitlement levels generally vary in the scope of the services and products available from the information technology resource center. Often, a primary user entitlement level is established that has full access to the entire set of services and products the customer is entitled to access in the information technology resource center. A secondary user entitlement level also can be established that has access to a subset of the services and products the customer is entitled to access in the information technology resource center.

In block 408, the caching entitlement set software 302a completes the login process. After block 408, the user is able to access the services and products of the information technology resource center according to the entitlement set.

If the caching entitlement set software 302a determines a dirty buffer 304 does exist in block 404, the caching entitlement set system goes to block 410. In block 410, the caching entitlement set software 302a calculates the entitlement set and eliminates the dirty buffer 304 (FIG. 3).

FIG. 5 is a flowchart illustrating another embodiment 302b of the caching entitlement set software 302 of FIG. 3. The caching entitlement set software 302b of FIG. 5 illustrates the functionality of another embodiment of the caching entitlement set system and method.

In block 402, the caching entitlement set software 302a receives a user login request.

In block 502, the caching entitlement set software 302b reads the user's personal information from the customer information database 308 (FIG. 3).

In block 504, the caching entitlement set software 302b reads linked agreements associated with the user. The linked agreements may be read from the linked agreement database 310 (FIG. 3). Linked agreements may change due to a number of events such as linking a new agreement, sharing an agreement with another registered user, re-assigning an agreement to another registered user. Events that change the linking agreements may also lead to the creation of a dirty buffer 304. The info read from linked agreements may be stored in memory 208 and may be made available to the user, the customer, and the organization to identity the linked agreements related to the user and to provide a description of products and services the user is entitled to access.

In block 404, the caching entitlement set software 302a determines whether a dirty buffer 304 (FIG. 3) exists for the user.

If the caching entitlement set software 302b determines a dirty buffer 304 (FIG. 3) does not exist in block 404, the caching entitlement set software 302b goes to block 406. In block 406, the caching entitlement set software 302b reads the entitlement set from the persistent entitlement set element 306 (FIG. 3).

In block 408, the caching entitlement set software 302b completes the login process. After block 408, the user is able to access the services and products of the information technology resource center according to the entitlement set.

If the caching entitlement set software 302b determines a dirty buffer 216 does exist in block 404, the caching entitlement set software 302b goes to block 506. In block 506, the caching entitlement set software 302b calculates entitlements based on the linked agreements read in block 504.

In block 508, the caching entitlement set software 302b calculates user level entitlements. The user level entitlements include free services and special service access. The user level entitlements are entitlements that are not based solely on linked agreements.

In block 410, the caching entitlement set software 302b calculates the entitlement set and eliminates the dirty buffer 304 (FIG. 3).

In block 510, the caching entitlement set software 302b stores the entitlement set calculated in block 410 in the persistent entitlement set element 306 (FIG. 3). From block 510, the caching entitlement set software 302b goes to block 408 where it completes the login process as described above.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A program for caching an entitlement set, the program being stored as a computer readable medium, the entitlement set designating services and products a user is entitled to access in a network, the program comprising: logic for:
(a) logic configured to receive a login request from the user;
(b) logic configured to determine whether a memory element indicating a triggering event related to the user exists, the memory element having been created after a triggering event;
(e) logic configured to read a preexisting entitlement set from a memory element if the dirty buffer does not exist, the preexisting entitlement set indicating a first scope of access to the network; and
(f) logic configured to calculate a new entitlement set if the dirty buffer does exist, the new entitlement set indicating a second scope of access to the network; and
(g) logic configured to allow the user a third scope of access to the network, the third scope of access being the first scope of access or the second scope of access.

2. The program of claim 1, wherein the login request includes user identification information and a password.

3. The program of claim 1, wherein the memory element is a dirty buffer.

4. The program of claim 3, wherein the dirty buffer identifies the triggering event.

5. The program of claim 1, wherein the triggering event is the creation of a new linking agreement.

6. The program of claim 1, wherein the triggering event is the creation of a contract with a customer.

7. The program of claim 1, wherein the preexisting entitlement set is read from a persistent memory element.

8. The program of claim 1, further comprising logic for:
allowing the user access to an information technology resource center, the scope of the access based on the entitlement set.

9. The program of claim 1, further comprising logic for:
reading a linked agreement associated with the user, wherein information read from the linked agreement is used to calculate the new entitlement set.

10. The program of claim 9, further comprising logic for:
calculating an entitlement based on the linked agreement, wherein the calculated entitlement is used to calculate the new entitlement set.

11. The program of claim 10, further comprising logic for:
calculating a user level entitlement, wherein the user level entitlement is used to calculate the new entitlement set.

12. A method for caching an entitlement set, the entitlement set designating services and products a user is entitled to access, the method comprising the steps of:
(a) receiving a login request from the user;
(b) determining whether a memory element indicating a triggering event related to the user exists, the memory element having been created after a triggering event;
(e) reading a preexisting entitlement set from a memory element if the memory element does not exist, the preexisting entitlement set indicating a first scope of access to the network; and
(f) calculating a new entitlement set if the memory element does exist, the new entitlement set indicating a second scope of access to the network; and
(g) allowing the user a third scope of access to the network, the third scope of access being the first scope of access or the second scope of access.

13. The method of claim 11, wherein the login request includes user identification information and a password.

14. The method of claim 11, wherein the memory element is a dirty buffer.

15. The method of claim 14, wherein the dirty buffer identifies the triggering event.

16. The method of claim 11, wherein the triggering event is the creation of a new linking agreement.

17. The method of claim 11, wherein the triggering event is the creation of a contract with a customer.

18. The method of claim 11, wherein the preexisting entitlement set is read from a persistent memory element.

19. The method of claim 11, further comprising the step of:
allowing the user access to an information technology resource center, the scope of the access based on the entitlement set.

20. The of claim 11, further comprising the step of:
reading a linked agreement associated with the user, wherein information read from the linked agreement is used to calculate the new entitlement set.

21. The method of claim 20, further comprising the step of:
calculating an entitlement based on the linked agreement, wherein the calculated entitlement is used to calculate the new entitlement set.

22. The method of claim 21, further comprising the step of:
calculating a user level entitlement, wherein the user level entitlement is used to calculate the new entitlement set.
